(19) United States
(12) Patent Application Publication
(10) Pub. No.: US 2007/0285513 A1
(43) Pub. Date: Dec. 13, 2007

(54) Printer emulator

(75) Inventor: John C. Arnold, Sellersburg, IN (US)

Correspondence Address: BROOKS KUSHMAN P.C., 1000 TOWN CENTER, TWENTY-SECOND FLOOR, SOUTHFIELD, MI, 48075, US

(73) Assignee: Image Vault, LLC, New Albany, IN (US)

(21) Appl. No.: 11/451,992

(22) Filed: Jun. 13, 2006

(51) Int. Cl. H04N 7/18

(52) U.S. Cl. 348/150; 348/160

(57) ABSTRACT

An emulator of the type suitable to simulate connection of an intended device to another device in the absence of an actual connection therebetween. The emulator may be configured to simulate any number of connections, such as but not limited to printer port, display port, and scale port connection. The emulator may be used with any number of elements, such as but not limited to point of sale (POS) device. The emulator may be configured to receive data from the port, and optionally, to transmit the received data to remote locations, such as through network communications.

### BACKGROUND OF THE INVENTION

1. Field of the Invention

The present invention relates to emulators of type used to simulate connections to a device.

2. Background Art

U.S. Pat. No. 6,421,080, the disclosure of which is hereby incorporated in its entirety, relates to a surveillance system of the type which records images as a function of triggering events, such as transactions at a point of sale (POS) device, like a cash register or other commerce related terminal/transaction point. This system and other similar systems require some form of communication from the POS device in order to determine the triggering events.

Some POS devices include a printer port for outputting printer data to a printer. This printer port can provide sufficient capabilities to support the above-identified communication requirements such that the triggering events may be determined as a function of the printer day. Other POS devices, however, may be unable to communicate printer data in this manner, unless a controller or other feature of the POS devices understands or otherwise believes a printer is connected thereto.

### SUMMARY OF THE INVENTION

One non-limiting aspect of the present invention relates to an emulator configured to emulate or otherwise simulate connection of an intended device to another device in the absence of an actual connection therebetween.

One non-limiting aspect of the present invention relates to a printer emulator configured for connecting to a printer port of a cash register and emulating a printer connection to the printer port such that the cash register determines the printer connection when a printer is not connected to the port.

The emulator may be further configured to transmit a printer connection message to the cash register, the printer connection message for use by the cash register in determining the printer connection. Optionally, the printer connection message may include a one-digit variable associated with indicating the printer connection, be selectively variable to support Data Terminal Equipment (DTE) and Data Communications Equipment (DCE) communications.

The emulator may be further configured to transmit the printer connection message at predefined intervals and/or in response to a query from the cash register.

The emulator may be configured to receive printer data from the cash register and to rely the printer data to a remotely located element.

One non-limiting aspect of the present invention relates to an image recording system for use with a cash register of the type which requires determination of a printer connection in order to transmit printer data. The system may include at least one camera for capturing images, at least one image recording element configured for processing images captured by the at least one camera as a function of the printer data, and a printer emulator in communication with the cash register and configured for emulating the printer connection so as to permit the printer data to be transmitted to the image recording element.

The emulator may be configured to transmit a printer connection message to the cash register that may be used in determining the printer connection. The printer connection message may include a one-digit variable associated with indicating the printer connection and/or transmitted to the printer connection message at predefined intervals or in response to a query from the cash register.

The emulator may be configured to transmit the printer data to the image recording element. For example, if the cash register includes a printer port for transmitting the printer data, the emulator may be configured to receive the printer data from the printer port for transmit to the image recording element.

One non-limiting aspect of the present invention relates to an emulator configured for simulating connection of an intended device to a port of a point of sale (POS) device. The emulator may be configured for connecting to the port of POS device and communicating a connection message to the port so as to emulate connection of the intended device to the port.

The emulator may be configured to simulate a printer connection, a display connection, and/or a scale connection.

The emulator may be configured to receive data from the port and to optionally transmit the received data to a remotely located element.

The emulator may be configured to selectively support Data Terminal Equipment (DTE) and Data Communications Equipment (DCE) communications.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description when taken in conjunction with the accompany drawing in which:

FIG. 1 illustrates a block diagram of an image recording system in accordance with one non-limiting aspect of the present invention.

### DETAILED DESCRIPTION OF THE PREFERRED EMBODIMENT(S)

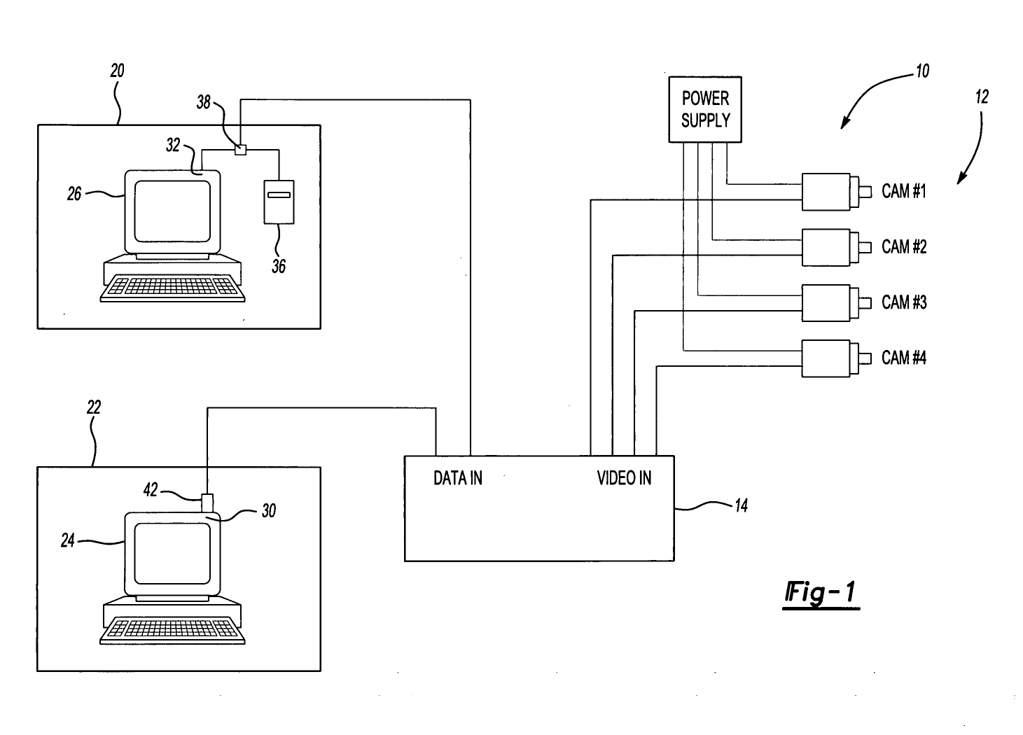

FIG. 1 illustrates a block diagram of an image recording system 10 in accordance with one non-limiting aspect of the present invention. The image recording system 10 may be suitable for use in any number of environments where it is desirable to record images captured with one or more cameras 12 and to store the captured images on a memory (not shown) of an image recording element 14 for subsequent retrieval and playback, such as in a manner similar to that described above with respect to U.S. Pat. No. 6,421,080.

For exemplary purposes, the present invention is predominately described with respect to point of sales (POS) or other commerce related environments were it may be desirable to record images associated with transactional activities of cashiers, tellers, and other individuals associated with customer purchases and the like. The present invention, however, is not intended to be so limited and fully contemplates its application to any number of other environments.

POS surveillance is of particular interest to vendors, retailers, and other proprietors or individuals that rely on employees or other personnel to track, monitor, and otherwise service customer consumption of services, products, and the like. The ability to record images attendant to a sales transaction or other similar activity allows the proprietor to visually inspect conditions attendant to the transaction. This can be helpful in catching fraudulent activities and otherwise verifying conditions proximate to the transaction.

Typically, one or more POS destinations 20-22 are provided at locations where the customer interacts with an employee, automated entity (user-driven checkouts, automatic teller machines (ATMs), and the like), or other representatives of the proprietor in order to purchase a product or otherwise obtain a service. These destinations 20-22 are commonly referred to as a checkout lines or kiosks. To facilitate the transactions, each location may include one or more POS devices 24-26 to collect data and execute other processing operations associated with the transaction.

The POS devices 24-26 may be a cash register, computer terminal, or other device having any number of capabilities for inputting and processing data associated with the transaction. The POS devices 24-26 may include input devices, output devices, and other processing and memory elements, such as but not limited to keyboards, displays, processors, hard-drives, scanners, and the like. When a customer desires to purchase a product, for example, a barcode on the product may be scanned by the POS devices 24-26 to determine its price and to facilitate other data collection and processing activities, such as compiling a bill, decrementing inventories, etc.

In some cases, the POS devices 24-26 may be configured to record the parameters of the sale, such as a product ID, cost, payment method, etc. These parameters may be stored on the POS devices 24-26 and/or remotely transmitted over cables, networks, and the like for storage on an inventory system, server, etc. (not shown). Optionally, the POS devices 24-26 may include ports 30-32, such as but not limited to a printer port, multimedia port, scale port, display port and the like, that may be used to output this data and other information associated with the transactions.

For example, the printer data may be used to output printer data associated with information of the transaction, such as timestamps, product descriptions, pricing, employee identification, purchaser identification, etc., including information commonly used to generate receipts. The POS devices 24-26 may be programmed or otherwise configured to provide the printer data according to any number of formats, variables, and parameters, as one having ordinary skill in the art will appreciate. Likewise, if the ports 30-32 are configurable for use in other operations, such as with scales and/or displays, the ports 30-32 may be used to output other pieces data and information associated with the functionality of the ports 30-32.

As shown, and without intending to limit the scope and contemplation of the present invention, the system includes a first POS device 26 and a second POS device 24, which for exemplary purposes are shown to be cash registers or other POS type devices that require a connection to the ports 30-32 in order to output information therefrom, such as but not limited to the type that require a printer connection in order to output the printer data. The TEC cash register, model number TEC-1595, and Micros cash register, model number E7, are examples of such limited capability POS devices.

These and other types of POS devices 24-26 which require the printer connection or some other connection may be generally characterized as limited capability elements in that they are limited in their ability to transmit data from the port if the desired connection is not present or active. More particular, these devices, due to programming or other built in functions, are only able to transmit the printer data if a proper connection message is determined or the some other connection to the ports 30-32 is otherwise understood to be active.

The first POS destination 20 in includes a printer 36 connected to the cash register 26. The printer 36 may be of type that provides the printer connection message to the port 32 such that the first POS device 26 understands there to a proper connection of the intended device. i.e., the printer 36. The message from the printer 36 may be configured and transmitted from in a manner conventionally known in the art. Because the proper connection message is received, the first POS device 26 is enabled to output the printer data or other data from the port 32.

A pass-through device 38 may be connected between the first POS device 26 and the printer 36 to relay the printer data to the image recording element 14, as described in the above referenced United States patent. This information may then be processed by the image recording element 14 to facilitate data associations with the images captured with the one or more cameras 12. In more detail, the image recording element 14 may associate the timestamps, employee/purchaser identification, and other elements of the data with the recorded images, such as to facilitate subsequent retrieval of images from particular transactions or time of day. This functionality can be helpful when retrieving particular images, analyzing transactions, and performing any number of other functions associated with the surveillance system 10.

Additionally, the image recording element 14 may be programmed or otherwise instructed to control/limit image recording as a function of the received data. For example, as memory demands may be rather large, the image recording element may be configured to limit image recordings to certain periods of time associated with a transaction. These periods of time may be determined as a function of timestamps or other indicators included within the data such that the image recording element deletes or otherwise stores portions of the recorded images that occur proximate in time to the time and/or events specified within the printer data.

In this manner, the image recording element 14 is able to store and/or process the images as a function of the data. Of course, the image recording element 14 may be configured to perform any number of other operations as a function of the data and the present invention is not intended to be limited to the foregoing.

The second POS destination 22 does not include a printer or other intended device connected to the port 30 of the second POS device 24. This creates a problem with respect to outputting data as the POS device 24 will not output data to the port 30 unless a proper connection is determined. If the port 30 is a printer port for outputting printer data, for example, the POS device 24 will not output the printer data unless a printer connection is determined. As described above, the port 30 may be associated with any number of functions such that the present invention is not intended to be limited to printer ports that output printer data.

In accordance with one non-limiting aspect of the present invention, a printer emulator 42 may be provided to simulate the desired connection to the port 30. The emulator 42 may be configured to generate a connection message, such as a printer connection message, for simulating a connection to a printer or other device that is intended to be connected to the port 30. The emulator 42, as such, simulates a proper connection even though no printer or other intended device is actually connected thereto, such as to trick the POS device 24 into believing a proper connection is active so that data may be outputted to the port 30.

The printer emulator 42 may be configured to define the connection message according to any number of parameters and variables, which may vary as a function of the POS device 24 and port configuration, its operating parameters, protocols, operating system, etc. For example, and without intending to limit the scope and contemplation of the present invention, the emulator 42 may be configured to generate the connection message such that it simulates a printer connection message comprising a single digit or bit. Optionally, the emulator 42 may be programmable, such as by connection to computer or other element having capabilities for providing a user interface or other mechanism to facilitate programming and re-programming the operation of the same.

In more detail, the emulator 42 may be selectively programmed after its manufacturing so that the characteristics of the connection message may be altered according to the POS device of interest. With respect to the printer connection message, for example, the emulator 42 may be selectively programmed to output the connection message on different pins or according to different parameters, such as to selectively support Data Terminal Equipment (DTE) and Data Communications Equipment (DCE) communications commonly employed with RS232 ports and connections.

In some cases, the POS device 24 may require a continuous determination of the port connection. This can be accomplished through any number of operations, including the POS device 24 checking for receipt of the message, i.e., passively receiving inputs at the port 30, or transmitting queries requesting the message, i.e., actively looking for the message. The emulator 42 may be configured to support any number of such requirements, including automatically providing the message, such as to support the POS device 24 continuously checking for the message, and/or it may be configured to respond to queries such that the message is provided only after receiving a query from the POS device 24.

Optionally, the emulator 42 may be configured in a manner similar to the above-identified pass-through feature 38 so as to facilitate transmission of the port data to the image recording element 14. The port data may be transmitted from the POS device 24 to the image recording element as long as the emulator 42 is successful in simulating the intended port connection. The transmission capabilities of the emulator 42 may be programmable and/or hard-coded and configured to support any number of transmission protocols and standards and transmissions of over any number of infrastructures, including wireline and wireless infrastructures.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A printer emulator configured for:
connecting to a printer port of a cash register; and
emulating a printer connection to the printer port such that the cash register determines the printer connection when a printer is not connected to the port.

2. The emulator of claim 1 further configured to transmit a printer connection message to the cash register, the printer connection message for use by the cash register in determining the printer connection.

3. The emulator of claim 2 wherein the printer connection message includes a one-digit variable associated with indicating the printer connection.

4. The emulator of claim 2 wherein the printer connection message is selectively variable to support Data Terminal Equipment (DTE) and Data Communications Equipment (DCE) communications.

5. The emulator of claim 2 further configured to transmit the printer connection message at predefined intervals.

6. The emulator of claim 2 further configured to transmit the printer connection message in response to a query from the cash register.

7. The emulator of claim 1 further configured to receive printer data from the cash register and to rely the printer data to a remotely located element.

8. An image recording system for use with a cash register of the type which requires determination of a printer connection in order to transmit printer data, the system comprising:
at least one camera for capturing images;
at least one image recording element configured for processing images captured by the at least one camera, the at least one image recording element configured to record the images as a function of the printer data; and
a printer emulator in communication with the cash register and configured for emulating the printer connection so as to permit the printer data to be transmitted to the image recording element.

9. The system of claim 8 wherein the emulator is configured to transmit a printer connection message to the cash register, the printer connection message for use by the cash register in determining the printer connection.

10. The system of claim 9 wherein the printer connection message includes a one-digit variable associated with indicating the printer connection.

11. The system of claim 9 wherein the emulator is configured to transmit the printer connection message at predefined intervals or in response to a query from the cash register.

12. The system of claim 9 wherein the printer emulator is configured to transmit the printer data to the image recording element.

13. The system of claim 12 wherein the cash register includes a printer port for transmitting the printer data and wherein the emulator is configured to receive the printer data from the printer port for transmit to the image recording element.

14. An emulator configured for simulating connection of an intended device to a port of a point of sale (POS) device, the emulator configured for:
connecting to the port of POS device; and
communicating a connection message to the port so as to emulate connection of the intended device to the port.

15. The emulator of claim 14 wherein the port is a printer port and wherein the emulator is configured to simulate a printer connection.

16. The emulator of claim 14 wherein the port is a display port and wherein the emulator is configured to simulate a display connection.

17. The emulator of claim 14 wherein the port is a scale port and wherein the emulator is configured to simulate a scale connection.

18. The emulator of claim 14 further configured to receive data from the port.

19. The emulator of claim 18 further configured to automatically transmit the received data to a remotely located element.

20. The emulator of claim 14 further configured to selectively support Data Terminal Equipment (DTE) and Data Communications Equipment (DCE) communications.
